(19) United States
(12) Patent Application Publication
(10) Pub. No.: US 2026/0194105 A1
(43) Pub. Date: Jul. 9, 2026

(54) WHEEL BEARING UNIT FOR SUPPORTING A MOTOR VEHICLE TIRE OF A MOTOR VEHICLE, AND METHOD FOR INSTALLING A WHEEL BEARING UNIT

(71) Applicant: Schaeffler Technologies AG & Co. KG, Herzogenaurach (DE)

(72) Inventor: Lukas Schraut, Werneck (DE)

(73) Assignee: Schaeffler Technologies AG & Co. KG, Herzogenaurach (DE)

(21) Appl. No.: 19/128,564

(22) PCT Filed: Oct. 10, 2023
(86) PCT No.: PCT/DE2023/100753

§ 371 Date: May 9, 2025

(30) Foreign Application Priority Data
Nov. 9, 2022 (DE) 10 2022 129 622.9

(51) Int. Cl. F16C 19/38; F16C 19/54

(52) U.S. Cl. CPC F16C 19/383; F16C 19/543; F16C 2326/02

(57) ABSTRACT

The disclosure relates to a wheel bearing unit for supporting a motor vehicle tire of a motor vehicle. The wheel bearing unit includes a rolling bearing with at least one outer ring and at least two inner rings, between which rolling bodies are guided, and a seal unit which is arranged between the outer ring and at least one of the two inner rings in a radial direction for sealing off the outer ring from the inner ring. The mutually facing axial end faces of adjacent inner rings are supported against each other, and the inner rings are connected together in a form-fitting and force-fitting manner at the respective axial end faces thereof facing one another.

### CROSS-REFERENCE TO RELATED APPLICATIONS

This application is the U.S. National Phase of PCT Application No. PCT/DE2023/100753 filed on Oct. 10, 2023, which claims priority to DE 10 2022 129 622.9 filed on Nov. 9, 2022, the entire disclosures of which are incorporated by reference herein.

### TECHNICAL FIELD

The disclosure relates to a wheel bearing unit for supporting a motor vehicle tire of a motor vehicle. The disclosure further relates to a method for installing a wheel bearing unit.

### BACKGROUND

Various wheel bearings are known in the prior art, particularly for motor vehicles and commercial vehicles. Wheel bearing units for commercial vehicles are often designed as insert rolling bearing units with tapered roller bearings. DE 10 2014 200 714 A1, for example, discloses a rolling bearing unit in the form of a multi-row angular contact bearing that can be used as a wheel bearing for a vehicle. This comprises two rows of rolling bodies, each of which is guided between an inner ring and an outer ring. The outer rings are usually pressed into a wheel hub. The end faces of the inner rings facing each other form a small gap. This gap between the inner rings in the untensioned state is referred to as preload in insert tapered roller bearings. Today, the wheel bearing is tensioned and fixed by fastening the axle nut to the axle journal. The gap between the inner rings is compressed until they touch, which introduces a tensioning force into the wheel bearing. This tensioning force is decisive for the service life and friction of the wheel bearing. In the prior art, this preload is designed and defined by the technician. However, this is subject to the influence of numerous components and their tolerances.

### SUMMARY

The object of the disclosure is to be able to introduce a defined preload into the wheel bearing which is as independent as possible of the tolerances of the other wheel bearing components in order to reduce friction in the wheel bearing and increase the service life of the wheel bearing.

The object is achieved according to the disclosure by a wheel bearing unit according to the features described herein and a method for installing the wheel bearing unit according to a method described herein.

The wheel bearing unit according to the disclosure for supporting a motor vehicle tire of a motor vehicle, in particular a truck, comprises a rolling bearing which is designed in at least two rows, at least two outer rings, and at least two inner rings. Rolling bodies are guided between the outer ring and the inner ring, and mutually facing axial end faces of the adjacent inner rings are supported against each other with axial end faces aligned with each other. The inner rings are connected together in a form-fitting and force-fitting manner at the respective axial end faces thereof facing one another.

A sufficiently high joining force ensures that the inner rings form a form-fitting and force-fitting connection. The preload in the wheel bearing and the associated tensioning force can therefore be precisely defined and fixed. The tensioning force applied to the wheel bearing cannot escape from the wheel bearing.

In an example embodiment, the rolling bodies are tapered rollers. The wheel bearing unit according to the disclosure can be used in commercial vehicles or trucks and is designed as an insert tapered roller bearing.

In an example embodiment, a seal unit for sealing off the outer ring with respect to the inner ring is arranged in the radial direction between at least one of the outer rings and at least one of the inner rings. The wheel bearing can have two seal units, and each seal unit is arranged between an outer ring and an inner ring.

The sealing of the wheel bearing prevents the ingress of dirt and water and thus considerably extends the service life of the bearing.

In an example embodiment, the inner rings form joints on their respective facing axial end faces, which interlock to form a form fit. A joint refers in particular to a step that is inserted in the end area of the inner ring. The joints can be hollow cylindrical or tubular in shape and are arranged concentrically to each other when the inner rings are in the installed state. In the installed state, the joints form a form-fitting and force-fitting connection.

The joint, preferably both joints, have a length of at least 20 mm in order to ensure sufficient stability.

In an example embodiment, the rolling bearing is axially fixed by a retaining ring such as a snap ring, in particular on the axle journal. As the rolling bearing is sufficiently tensioned by the form-fitting and force-fitting connection of the inner rings, an axial fixing with an axle nut is no longer necessary. A snap ring is therefore sufficient for fixing and also offers advantages in terms of process simplification and weight savings.

The disclosure also relates to a method for installing a wheel bearing, wherein two rolling body sets are inserted into a wheel hub and a preload of the wheel bearing is set by a predefined target press-in distance of two inner rings, which are connected to one another in a form-fitting and force-fitting manner.

The target press-in distance Xges is determined by X0-Xvs, where X0 is an axial distance between a second end face of the inner ring and an end face of the outer ring and Xvs is a travel distance (or displaced distance) resulting from a predefined target preload that the wheel bearing should have.

During installation, the first row of rolling bodies is first loaded with a slight preload and the distance X0 is determined. The first row of rolling bodies or the first rolling body set is then pressed axially onto the wheel hub via the first outer ring. The second row of rolling bodies or the second rolling body set is then pressed axially onto the wheel hub via the second outer ring, wherein the outer end faces of the first and second inner ring touch each other when the second row is pressed in, causing the first inner ring to move axially outwards. The first inner ring is then pressed in axially with a predefined press-in force, whereby the joints on the inner rings interlock at the end faces and form a force-fitting and form-fitting connection. The target press-in distance Xges of the inner rings is defined as X0-Xvs and can therefore apply a predefined preload to the wheel bearing.

The method according to the disclosure makes it possible to set a defined, very precise preload and thus a fixed friction. Many dimensions and tolerances no longer have any influence on the preload of the bearing, which enables more cost-effective production of the bearing.

### BRIEF DESCRIPTION OF THE DRAWINGS

Further features of the disclosure are apparent from the following description of the figures, in which exemplary embodiments of the disclosure are shown, although the disclosure is not limited to these embodiments. In the drawings:

FIG. 1 shows a half section of a wheel bearing or a wheel bearing unit with a double-row rolling bearing;

FIGS. 2a-2d show the installation steps of the wheel bearing;

FIG. 2e shows a detailed view of the inner rings during installation according to FIG. 2c;

FIG. 2f shows a detailed view of the installed inner rings according to FIG. 2d;

FIG. 3 shows a sectional view of the inner rings in a not yet fully installed state; and

FIG. 4 shows a section of an installed wheel bearing on an axle journal.

### DETAILED DESCRIPTION

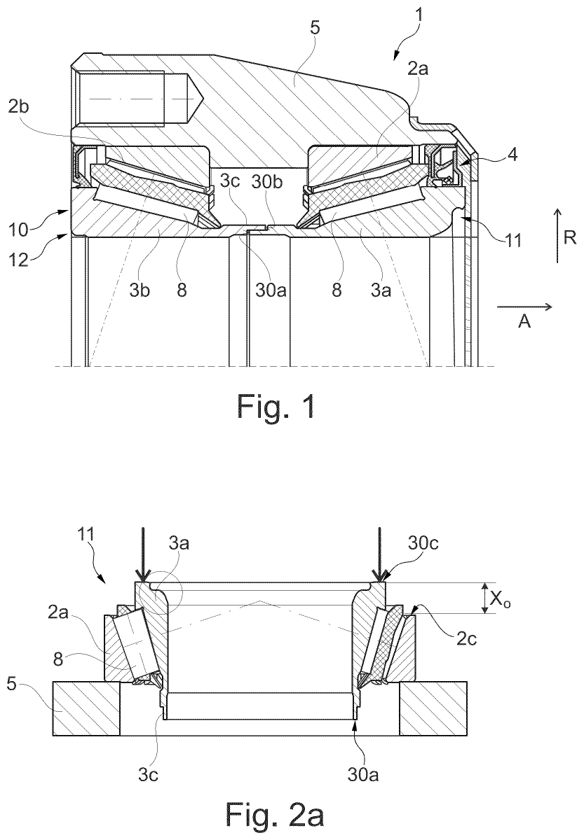

FIG. 1 shows a sectional view of a wheel bearing or a wheel bearing unit 1 with a rolling bearing 10 that has two rolling body sets 11, 12. A rolling body set 11, 12 comprises at least one outer ring 2a, 2b and one inner ring 3a, 3b as well as rolling bodies 8 guided therebetween. The rolling bodies 8 can be designed as tapered rollers. The rolling body sets 11, 12 are pressed into a wheel hub 5. For this purpose, the wheel hub 5 has axial stops to which the outer rings 2a, 2b are axially fixed. A seal unit 4 is arranged between the inner ring 3a, 3b and the outer ring 2a, 2b. The seal unit 4 prevents dirt and water from entering the bearing. Axially outside the seal unit 4, a sensor device is shown (only in part). In particular, this comprises a pole wheel, which is attached to the wheel hub 5, and a sensor (not shown) for speed detection.

The inner rings 3a, 3b have joints 3c or steps on their facing end faces 30a, 30b. These are hollow cylindrical and can therefore interlock when in the installed state. In the installed state, the joints 3c are arranged concentrically to each other.

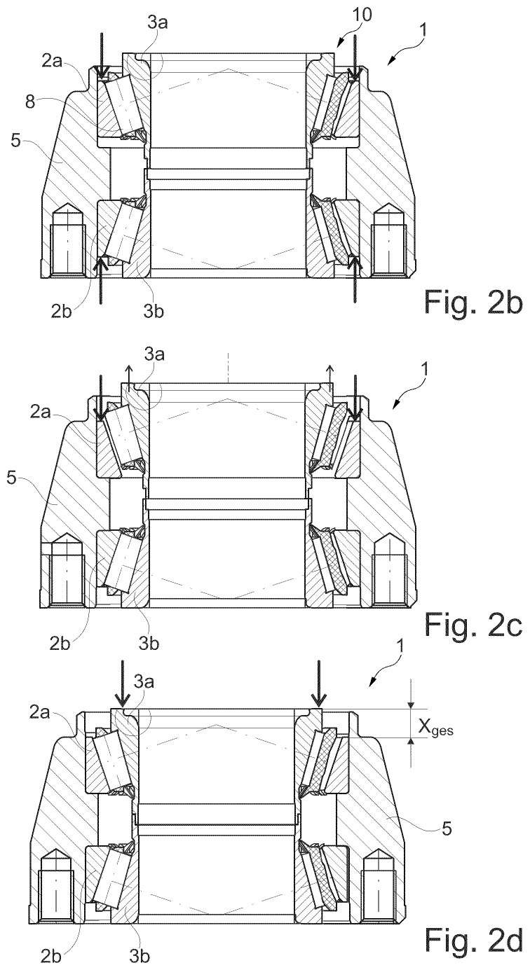

When mounting the wheel bearing unit, a rolling body set 11 is first pressed axially against a stop and loaded with a slight initial force. This is shown in FIG. 2a. The distance X0 is determined. X0 is the axial distance between a second end face 30c of the inner ring 3a and the end face of the outer ring 2a. In the next method step (see FIG. 2b), the two rolling body sets 11, 12 are pressed into the wheel hub 5 one after the other. This results in contact between the end faces 30a, 30b of the inner rings 3a, 3b, which pushes the inner ring 3a axially outwards (see FIG. 2c). The inner ring 3a is then pressed axially in the direction of the inner ring 3b using a high press-in force, for example at least 100 kN, which generates a force fit and form fit at the joints 3c of the inner rings 3a, 3b (FIG. 2d). The press-in force must be high enough to prevent further press-in by tightening an axle nut. The target press-in distance Xges is the already determined value X0 minus the travel distance Xvs to achieve the target preload force. The wheel hub 5 is tensioned via the defined preload travel distance Xvs and thus with a defined tensioning force using this installation method. The preload can no longer escape from the system.

FIG. 2e shows a detailed view in which the inner rings 3a, 3b are shown before the final installation step, in which the inner rings 3a, 3b touch each other but are not yet connected in a force-fitting and form-fitting manner (FIG. 2e). FIG. 2f shows the inner rings 3a, 3b after installation has been completed, wherein the inner rings 3a, 3b are connected in a force-fitting and form-fitting manner.

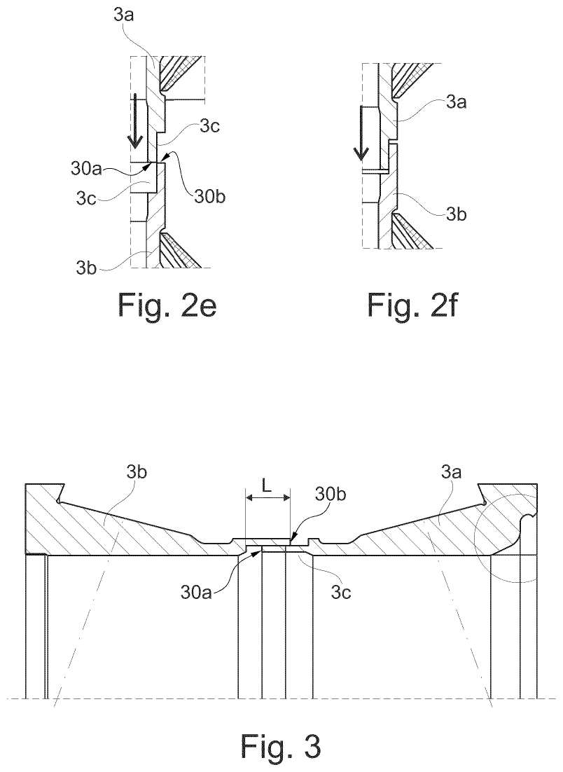

FIG. 3 shows a sectional view of the inner rings 3a, 3b during installation. The joints 3c of the two inner rings 3a, 3b partially overlap axially (or nested axially) and are then pushed further together until they form a force fit and form fit. The length L of the joints 3c can be at least 20 mm long.

Alternatively, the following method (not shown) can be used to install the wheel bearing unit 1. In a first step, the first rolling body set 11 with inner ring 3a is pressed axially into the wheel hub 5. For this purpose, the wheel hub 5 has one or two axial stops in the form of steps. In the next step, the inner ring 3a is loaded with a slight initial force and the distance X0 is determined. The second rolling body set 12 is then pressed into the wheel hub 5, causing the inner ring 3a with the rolling bodies 8 to slide axially out of the wheel bearing, as the end faces 30a, 30b of the inner rings touch each other. The inner ring 3a is then pressed back into the bearing or wheel hub 5 with a high press-in force so that a force fit and form fit is formed on the inner rings 3a, 3b. The wheel hub 5 rotates during the press-in process. The target press-in distance Xges is determined as described above using X0 minus Xvs.

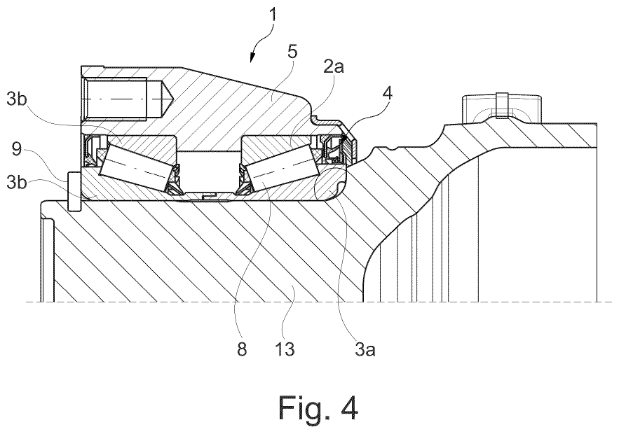

FIG. 4 shows the wheel bearing unit 1 with the installed rolling bearing 10. Tensioning of the wheel bearing unit 1 by an axle nut, as is known in the prior art, is no longer necessary here, as the unit 1 is already tensioned by a frictional connection or frictional engagement between the inner rings 3a, 3b. The unit 1 is therefore only fixed axially on an axle journal 13 by a retaining ring 9, such as a snap ring.

### LIST OF REFERENCE SYMBOLS

1 Wheel bearing unit
2a, 2b Outer ring
2c End face of the outer ring
3a, 3b Inner ring
3c Joints
4 Seal unit
5 Wheel hub
8 Rolling body
9 Retaining ring
10 Rolling bearing
11, 12 Rolling body sets
13 Axle journal
30a, 30b End faces
30c Second end face
R Radial direction
A Axial direction
Xges Target press-in distance

1. A wheel bearing unit for supporting a motor vehicle tire of a motor vehicle, the wheel bearing unit comprising:
a rolling bearing having:
at least two outer rings,
at least two inner rings, and
rolling bodies guided between each one of the at least two outer rings and a corresponding one of the at least two inner rings, and
wherein mutually facing axial ends of two of the at least two inner rings are supported against each other such that the mutually facing axial ends are connected together in a form-fitting and force-fitting manner so as to set a predefined target preload of the wheel bearing unit.

2. The wheel bearing unit according to claim 1, wherein the rolling bodies are configured as tapered rollers.

3. The wheel bearing unit according to claim 1, further comprising a seal unit arranged radially between at least one of the at least two outer rings and at least one of the at least two inner rings.

4. The wheel bearing unit according to claim 1, wherein two of the at least two inner rings have joints on their respective facing axial ends, which interlock in order to form a form fit.

5. The wheel bearing unit according to claim 4, wherein the joints have a length of at least 20 mm.

6. The wheel bearing unit according to claim 4, wherein the joints are hollow cylindrical and are arranged concentrically to one another.

7. The wheel bearing unit according to claim 1, wherein the rolling bearing is axially fixed via a retaining ring.

8. A method for installing a wheel bearing unit according to claim 1, comprising:
inserting two rolling body sets into a wheel hub, and
setting the predefined target preload of the wheel bearing unit via a predefined target press-in distance of one of the two of the at least two inner rings.

9. The method according to claim 8, wherein the predefined target press-in distance is determined by X0-Xvs, where X0 is an axial distance between a second end face of the one of the two of the at least two inner rings and an end face of a corresponding one of the at least two outer rings and Xvs is a travel distance of the second end face relative to the end face to achieve the predefined target preload.

10. A wheel bearing unit for supporting a motor vehicle tire of a motor vehicle, the wheel bearing unit comprising:
a rolling bearing having:
two outer rings,
two inner rings, and
rolling bodies disposed between each one of the two outer rings and a corresponding one of the two inner rings, and
wherein axial ends of two inner rings engage and overlap with each other in a form-fitting and force-fitting manner so as to set a predefined target preload of the rolling bearing.

11. The wheel bearing unit of claim 10, wherein the axial ends define steps that interlock with each other.

12. The wheel bearing unit of claim 10, wherein the axial ends are tubular shaped.

13. The wheel bearing unit of claim 10, further comprising a retaining ring configured to retain the rolling bearing to an axle journal.

14. The wheel bearing unit of claim 13, wherein the retaining ring does not set the predefined target preload of the rolling bearing.

15. The wheel bearing unit of claim 10, wherein the predefined target preload of the rolling bearing is set without use of an axle nut.

16. A method for assembling a wheel hub unit, comprising:
providing:
a first tapered rolling bearing having a first inner ring and a first outer ring;
a second tapered rolling bearing having a second inner ring and a second outer ring; and
a wheel hub;
pressing the first tapered rolling bearing onto the wheel hub via the first outer ring;
pressing the second tapered rolling bearing onto the wheel hub via the second outer ring such that a first axial end of the first inner ring abuts with a second axial end of the second inner ring; and
pressing the first inner ring via a predefined axial force so that the first axial end frictionally engages the second axial end so as to: i) fix the first axial end to the second axial end, and ii) set a predefined target preload of the first tapered rolling bearing and the second tapered rolling bearing.

17. The method of claim 16, wherein the first axial end and the second axial end define steps that interlock with each other so as to set the predefined target preload of the first tapered rolling bearing and the second tapered rolling bearing.

18. The method of claim 16, wherein the first axial end and the second axial end are tubular shaped.

19. The method of claim 16, wherein the first axial end overlaps with the second axial end so as to set the predefined target preload of the first tapered rolling bearing and the second tapered rolling bearing.

20. The method of claim 16, wherein the second axial end is nested within the first axial end.
